(19) United States
(12) Patent Application Publication
(10) Pub. No.: US 2014/0311521 A1
(43) Pub. Date: Oct. 23, 2014

(54) MULTIFUNCTIONAL ORAL HYGIENE SYSTEM

(71) Applicant: Ricardo Manuel Souza Mourra, Tegucigalpa M.D.C. (HN)

(72) Inventor: Ricardo Manuel Souza Mourra, Tegucigalpa M.D.C. (HN)

(21) Appl. No.: 13/867,044

(22) Filed: Apr. 20, 2013

(51) Int. Cl. A61C 15/04; A46B 15/00

(52) U.S. Cl. CPC A61C 15/046; A46B 15/0071; A46B 15/0081
USPC 132/309

(57) ABSTRACT

This device is a dental tool that has the integration of three components in a single device: a) Tooth brush, with standard measurements and norms, b) Waxed Dental Floss, up to 50 m rotating reel or cone, and c) Tongue cleaner, with standard measurements and norms. This can be done with a number of different designs whose purpose is providing the ease of having all the basic elements for a complete oral hygiene together. In addition it is very useful and practical to avoid forgetting any of the elements when carrying out oral cleaning and when traveling.

### CROSS-REFERENCES TO RELATED APPLICATIONS

None

### FIELD OF THE INVENTION

The present invention relates generally to a MULTIFUNCTIONAL ORAL HYGIENE SYSTEM and, more practically, to a tooth brush, floss dispenser and tongue cleaner combination device.

### BACKGROUND OF THE INVENTION

Dentists recognized that brushing and flossing are two of the most important activities for good dental care as well as using a tongue cleaner. The American Dental Association (ADA) recommends brushing one's teeth twice a day and cleaning between the teeth with floss once each day to remove plaque from all the surfaces of the tooth. It is also recommended to use a tongue cleaner to remove excess plaque and material. According to an ADA study in 2003, 94% of Americans say they brush nightly; 81% say they brush first thing in the morning. It has been reported that only 28% percent of Americans say they floss daily meaning that most people do not floss as frequently as they brush. One reason for this may be that in the current art the toothbrush and the floss container and tongue cleaner are typically separate, distinct units. While traveling it is hard for someone to remember to bring three different dental devices/units.

An objective of the present invention is to promote good dental care.

A further objective of the present invention is to make brushing and flossing convenient by having both the brush and the floss in one apparatus.

A further objective of the present invention is to provide a device where the floss can be easily replaced or refilled.

A further objective of the present invention is to provide a device where the floss is enclosed within the handle when the brush is being used.

A further objective of the present invention is to provide a device that includes a cutter for cutting off segments of floss.

A further objective of the present invention is to provide a device that can be easier to use while traveling.

The means and method of accomplishing these and other objectives will become apparent from the following description of the invention.

U.S. Pat. No. 8,015,982 by Wilkinson and issued on Sep. 13, 2011 is for a Toothbrush and flossing system. U.S. Pat. No. 7,237,560 by Macias, et al. and issued on Jul. 3, 2007 is for a disposable combination toothbrush and dental floss holder. U.S. Pat. No. 7,201,172 by Nanda and issued on Apr. 10, 2007 is for a toothbrush having flossing dispenser on handle. U.S. Pat. No. 7,198,051 by Festa and issued on Apr. 3, 2007 is for a combination toothbrush-dental floss dispenser. U.S. Pat. No. 6,390,103 by Manso and issued on May 21, 2002 is for a toothpaste dispensing toothbrush having floss dispenser. U.S. Pat. No. 6,095,157 by Brown and issued on Aug. 1, 2000 is for a toothbrush with a detachable and disposable bristle head and attached floss dispensing unit. U.S. Pat. No. 5,950,641 by Taveras and issued on Sep. 14, 1999 is for a dental floss and toothpick dispensing compartment for toothbrushes. U.S. Pat. No. 5,676,167 by Garner and issued on Oct. 14, 1997 is for a toothbrush and floss apparatus.

While other tooth brush devices may be suitable for the purposes for which they were designed, they would not be as suitable for the purposes of the present invention, as hereinafter described. What is needed is a device that provides the benefits of having flossing and brushing equipment and tongue cleaner and material in a single device that readily enables such aspects of dental hygiene.

There is still room for improvement in the art.

### SUMMARY OF THE INVENTION

The current invention consists of the integration of three components in a single device:
a) Tooth brush, with standard measurements and norms.
b) Waxed Dental Floss, up to 50 m rotating reel or cone.
c) Tongue cleaner, with standard measurements and norms.

There are different designs of the device whose purpose is providing the ease of having all the basic elements for a complete oral hygiene together. In addition it is very useful and practical to avoid forgetting any of the elements when carrying out oral cleaning and when traveling.

### BRIEF DESCRIPTION OF DRAWINGS

Without restricting the full scope of this invention, the preferred form of this invention is illustrated in the following drawings in which:

FIG. 1A is a view of the dental floss extraction channel in the handle;

FIG. 1B is a view of the front half of the device;

FIG. 2A is a view of the dental floss extraction channel in the handle of the second embodiment;

FIG. 2B is a view of the front half of the toothbrush of the second embodiment;

FIG. 3 displays the floss cone embodiment;

FIG. 4 displays the lid and plastic hinge; and

FIG. 5 displays the tongue cleaner.

### DETAILED DESCRIPTION OF THE PREFERRED EMBODIMENT

There are a number of significant design features and improvements incorporated within the invention.

The Utility Model to be patented consists of the integration of three components in a single device:
a) Tooth brush, with standard measurements and norms.
b) Waxed Dental Floss, up to 50 m rotating reel or cone.
c) Tongue cleaner, with standard measurements and norms.

There are different designs of the device whose purpose is providing the ease of having all the basic elements for a complete oral hygiene together, will be patented. In addition it is very useful and practical to avoid forgetting any of the elements when carrying out oral cleaning and when traveling.

The current invention also leads to savings in its manufacture, by taking advantage of the same structure for two or three components, which will lead to a saving for the consumer as well.

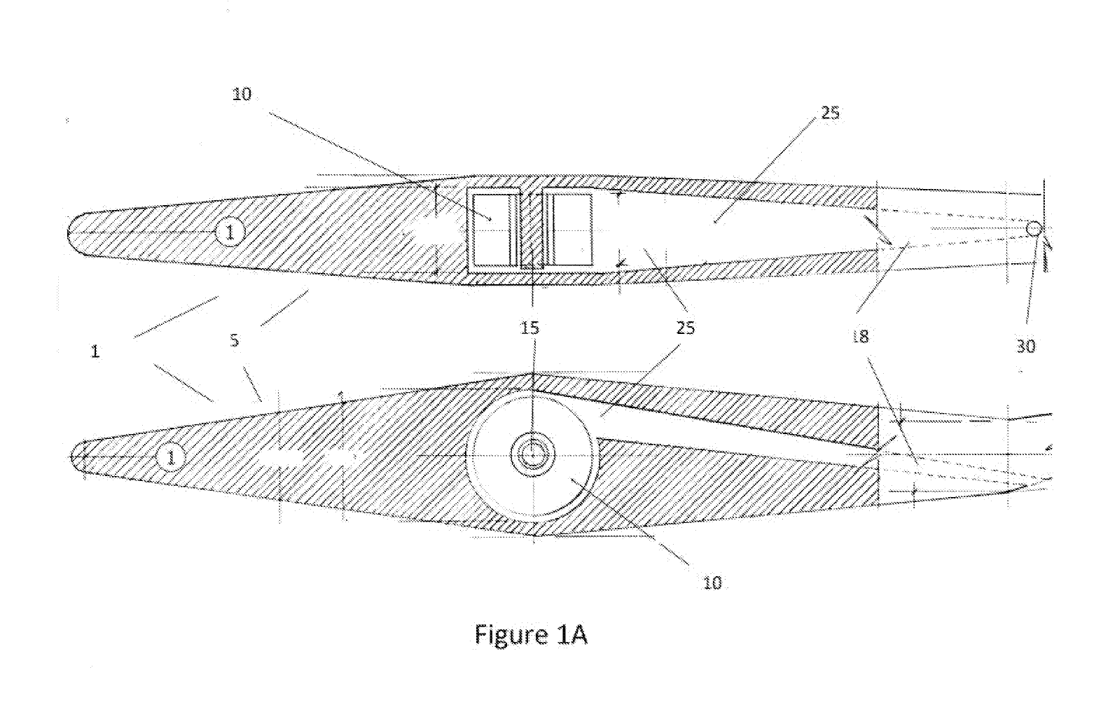

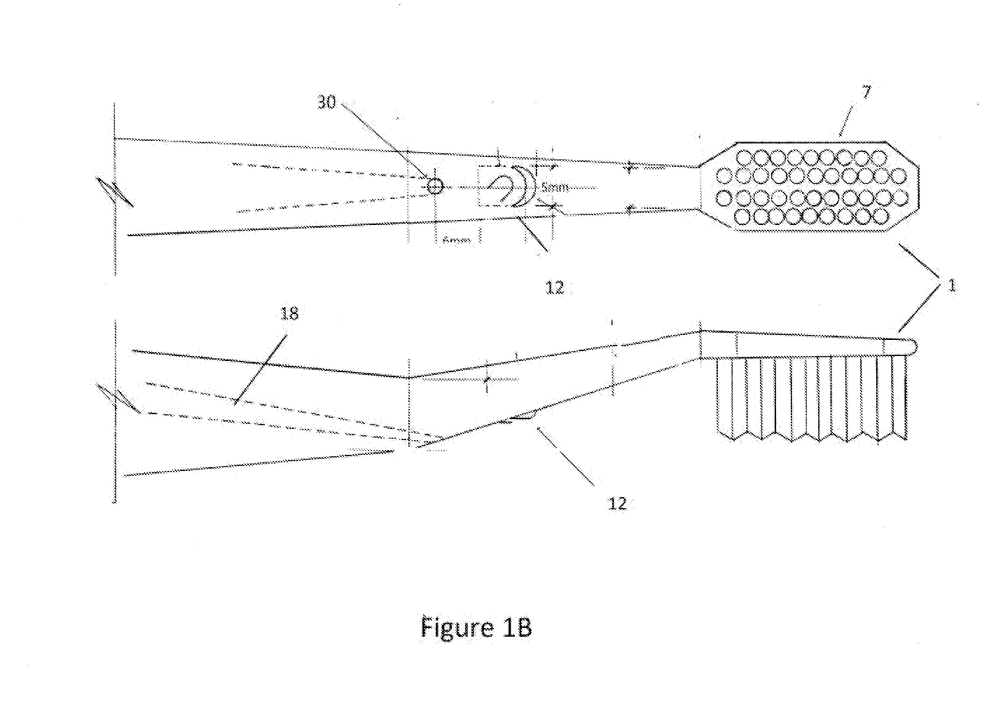

FIGS. 1A and 1B show the device 1 as a tooth brush with a floss wheel 10 that contains floss. The device 1 has a handle 5 end and a bristles end 7 and which the bristles 8 extend perpendicularly from the lower side. A rotating flow wheel 10 of floss is incorporated on the axle, on the internal part of the handle 5, with floss dispenser on the front dispensing out of a floss extraction hole 30 which in the preferred embodiment is located bottom side between the handle 5 and the bristles 8. The floss wheel 10 is connected to the device by a flow wheel axis 15 which about the floss wheel 10 rotates as the floss is dispensed from the floss wheel 10. The device 1 would have a cutting and holding plate 12, which will hold the floss while it is not being used and used by the user to cut the floss to its desired length and located next the floss extraction hole 30. The floss wheel 10 would be in an internal cavity 25 which would extend from the flow wheel axis 15 to the floss extraction hole 30 at a downward angle through the floss extraction channel 18.

The cutting and holding plate 12 would be similar to those that are currently being used on floss dispensers with a metal or plastic tab which is used to hold the floss when not being used and to cut it to the desired length by pulling against the edge of the cutting plate.

The dimensions are those of a standard toothbrush with ergonomic handle. The floss reel will be located on the central internal part of the handle and will contain up to 50 m of waxed floss, which will be taken from the rear of the handle through a dispenser with cutting and holding plate.

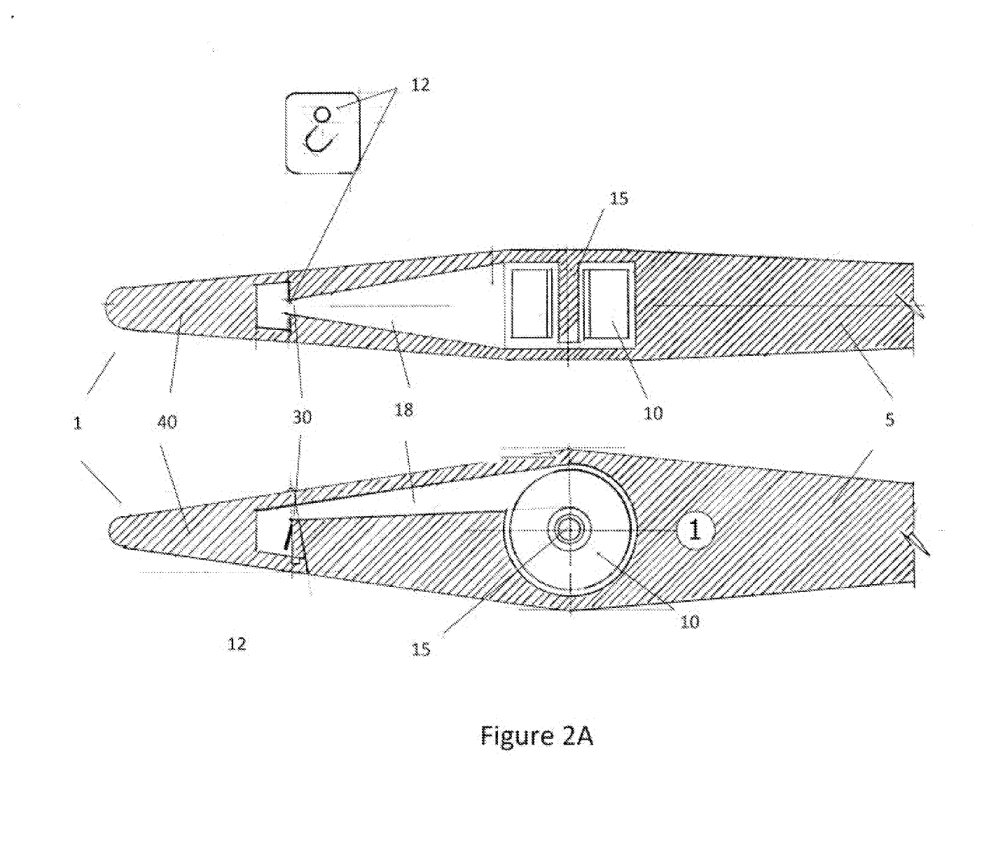

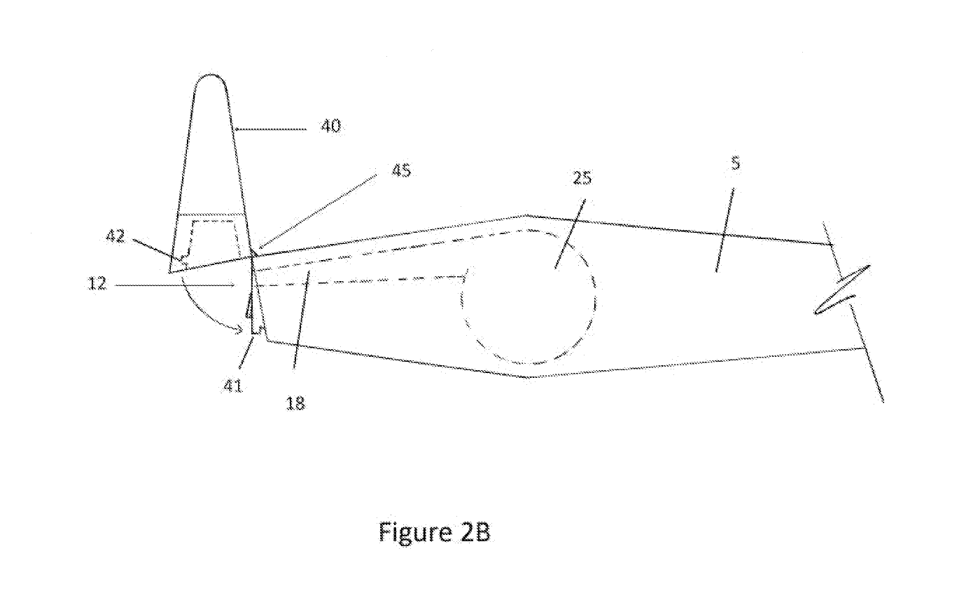

FIG. 2A and 2B shows an embodiment with the device 1 with rotating floss reel 10 incorporated on the axle, on the internal part of the handle, with floss extraction hole 30 on the rear, with a lid 40 having a lid hinge 45 covering the floss extraction hole 30.

The dimensions are those of a standard brush with ergonomic handle. The floss reel 10 will be located on the central internal part of the handle 5 and will contain up to 50 m of waxed floss, which will be taken from the rear of the handle through a floss extraction hole 30 with cutting and holding plate 12, which will be covered with a mobile lid 40 and hold the floss while it is not being used and used by the user to cut the floss to its desired length. The lid 40 would snap in place when closed with a lid tab 41 on the device 1 clicking into the lid tab indentation 42 holding the lid 40 close.

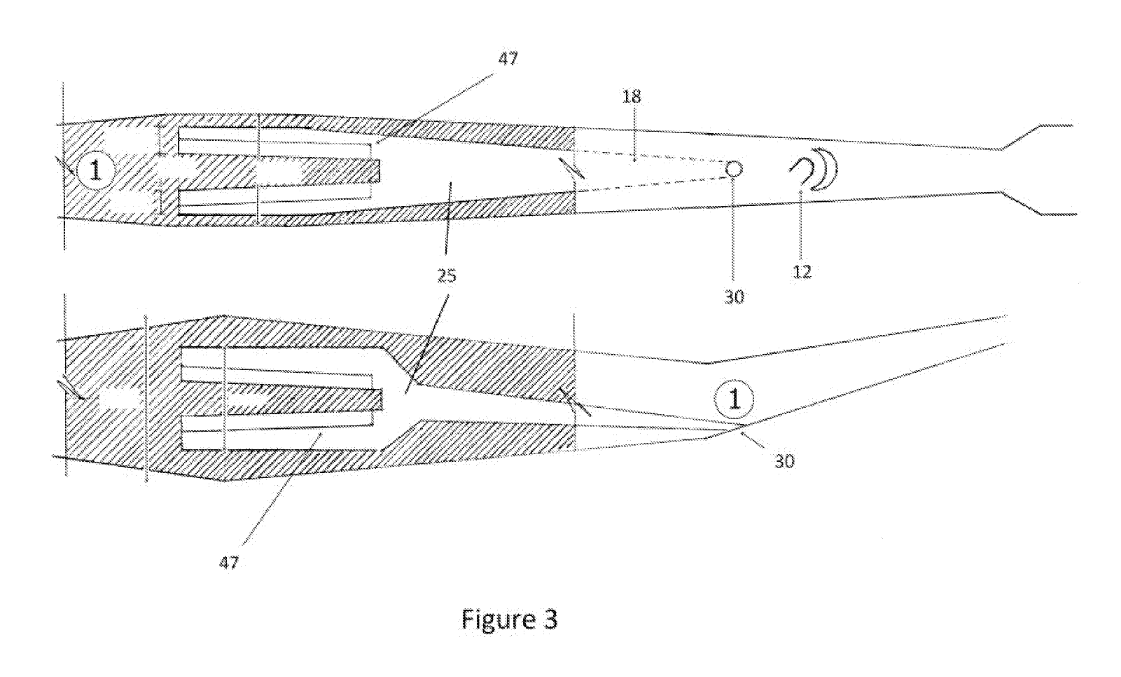

FIG. 3 shows the device 1 with a dental floss fixed cone 47 on which floss would be incorporated in the internal part of the handle in the internal cavity 25 which would extend from the dental floss fixed cone 47 to the floss extraction hole 30 at a downward angle. In this embodiment, the floss fixed cone 47 extends forward towards the bristles 8.

The dimensions are those of a standard brush with ergonomic handle. The floss cone 47 will be located on the central internal part of the handle and will contain up to 50 m of waxed floss.

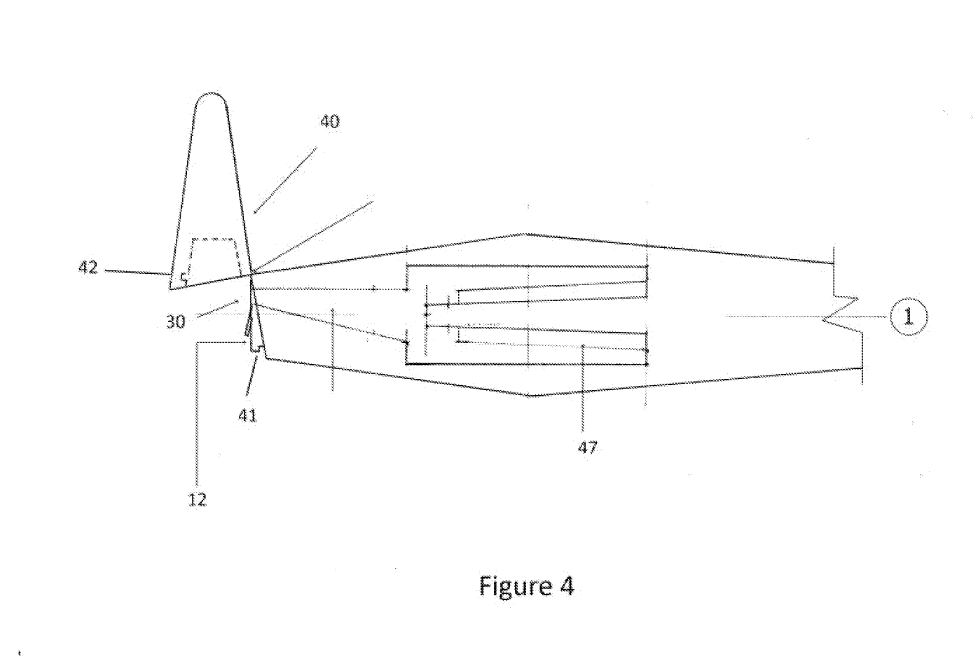

FIG. 4 displays the device with the floss cone 47 incorporated on the internal part of the handle, with floss dispenser on the rear. The floss cone 47 would taper towards the rear of the device 1 with floss extraction hole 30 at the rear of the device 1, with a lid 40 having a lid hinge 45 covering the floss extraction hole 30. The dimensions are those of a standard brush with ergonomic handle. The floss cone will be located on the central internal part of the handle and will contain up to 50 m of waxed floss, which will be taken from the rear of the handle through the floss dispenser hole 30 with cutting and holding plate, which will be covered with a mobile lid.

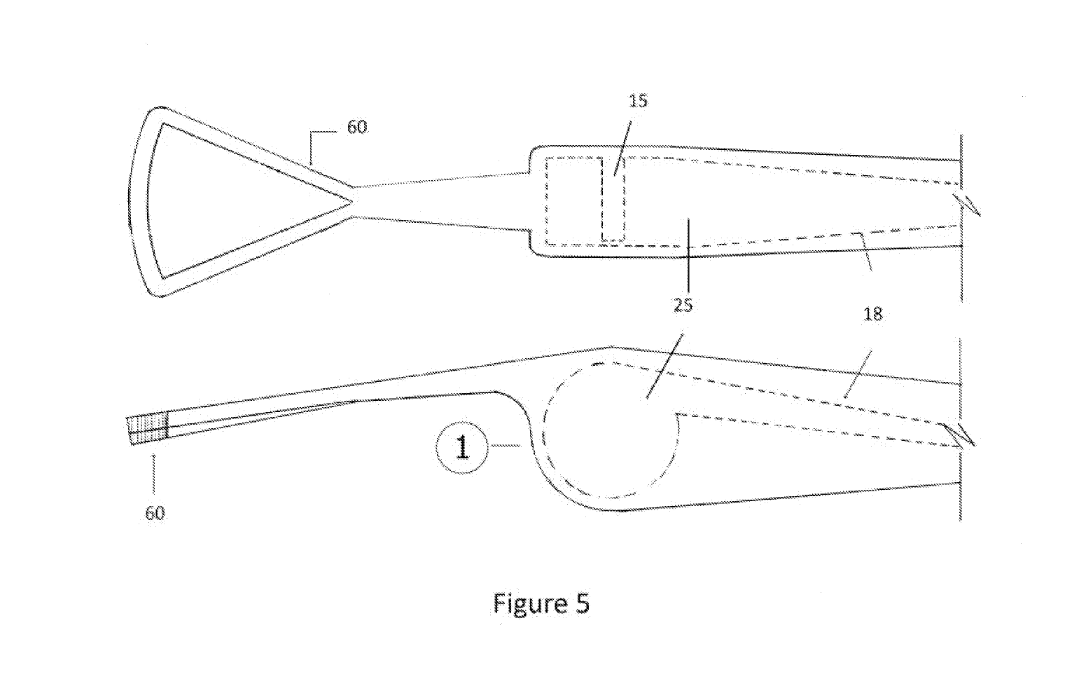

FIG. 5 displays the device 1 with the floss wheel 10 incorporated on the axle, on the internal part of the handle, with floss dispenser hole 30 on the front, and Tongue Cleaner 60 on the rear of the handle 5. The dimensions are those of a standard brush with ergonomic handle. The floss reel 10 will be located on the central internal part of the handle 5 and will contain up to 50 m of waxed floss, which will be taken from the rear of the handle through a dispenser with cutting and holding plate.

A Tongue Cleaner 60 will be of triangular shape with standard measurements and is attached to the rear of the handle 5. This could also be used with any of the other embodiment such as the fixed cone 47 systems with the dispenser in either the front or back facing position or the floss extraction hole 30 being in the back position on the device 1. The tongue cleaner could also be attached to the end of the lid 40.

As to a further discussion of the manner of usage and operation of the present invention, he same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur by those skilled in the art, it is not desired to limit the invention to the exact construction and operation shown and described, and accordingly, all suitable modifications and equivalents may be resorted to, falling within the scope of the invention.

I claim:

1. A dental device comprising:
a handle at one end and a bristles at the other end with a floss supply means in an internal cavity which extends from the supply means through a channel to a floss extraction hole.

2. A device according to claim 1 further comprising having said supply means being a rotating flow wheel connected by a flow wheel axis.

3. A device according to claim 1 further comprising having said supply means being a floss reel cone.

4. A device according to claim 1 further comprising having the floss extraction hole in the front.

5. A device according to claim 1 further comprising having the floss extraction hole in the back.

6. A device according to claim 5 further comprising having a lid in the back of the handle with a lid hinge covering the floss extraction hole.

7. A device according to claim 2 further comprising having the floss extraction hole in the front.

8. A device according to claim 2 further comprising having the floss extraction hole in the back.

9. A device according to claim 8 further comprising having a lid in the back of the handle with a lid hinge covering the floss extraction hole.

10. A device according to claim 3 further comprising having the floss extraction hole in the front.

11. A device according to claim 3 further comprising having the floss extraction hole in the back.

12. A device according to claim 11 further comprising having a lid in the back of the handle with a lid hinge covering the floss extraction hole.

13. A device according to claim 1 further comprising having a cutting and holding plate.

14. A device according to claim 13 further comprising having the cutting and holding plate located at the front of the device.

15. A device according to claim 13 further comprising having the cutting and holding plate located at the back of the device.

16. A device according to claim 1 further comprising having a tongue cleaner connected to the back of the device.

17. A device according to claim 2 further comprising having a tongue cleaner connected to the back of the device.

18. A device according to claim 3 further comprising having a tongue cleaner connected to the back of the device.

19. A device according to claim 9 further comprising having a tongue cleaner connected to the lid.

20. A device according to claim 12 further comprising having a tongue cleaner connected to the lid.
